(19) United States
(12) Patent Application Publication
(10) Pub. No.: US 2025/0190279 A1
(43) Pub. Date: Jun. 12, 2025

(54) CONTROL APPARATUS, CONTROL METHOD, AND PROGRAM

(71) Applicant: NIPPON TELEGRAPH AND TELEPHONE CORPORATION, Tokyo (JP)

(72) Inventors: Akito SUZUKI, Tokyo (JP); Masahiro KOBAYASHI, Tokyo (JP)

(21) Appl. No.: 18/843,498

(22) PCT Filed: Apr. 1, 2022
(86) PCT No.: PCT/JP2022/017008

§ 371 Date: Sep. 3, 2024

(51) Int. Cl. G06F 9/50; H04L 45/00

(52) U.S. Cl. CPC G06F 9/5083; H04L 45/00

(57) ABSTRACT

The present disclosure aims to improve the efficiency of task offloading in consideration of network usage statuses such as network topology and bandwidth. To this end, the present disclosure provides a control apparatus that controls allocation of a task to a physical network constructed and modeled by nodes having edge nodes and cloud nodes, the control apparatus including: an observation unit that observes task information regarding the task requested by an end device and network usage information indicating a usage status of the physical network; a calculation unit that calculates an optimal specific node for offloading the task based on the observation result of the observation unit; and a transfer unit that transfers the task to the specific node.

### TECHNICAL FIELD

The present disclosure relates to network and cloud control technology, and in particular, relates to control for allocating tasks.

### BACKGROUND ART

With the development of communication technology, a variety of applications are emerging in various fields such as healthcare, smart cities, and manufacturing. These applications are offloaded to cloud servers for processing because end devices (EDs) such as personal computers, smartphones, IoT devices, and automobiles have limited computing resources.

This mechanism is called cloud computing (CC). Tasks of the offloaded applications include computing resource requests and communication requests with different characteristics, such as traffic-heavy characteristics, compute-heavy characteristics, and latency (delay time)-sensitive characteristics.

Here, the term “traffic-heavy task” refers to a task that requires a large amount of traffic. The term “latency-sensitive task” refers to a task that has strict requirements regarding communication delay. Because cloud servers are typically located far away from end devices, additional communication delays are inevitably incurred when end devices offload tasks to the cloud. Therefore, cloud computing poses a problem in that it degrades the performance of tasks that are sensitive to delays.

In order to address the above problem, edge computing (EC) has been proposed in which computing resources are placed on edge servers close to end devices. Combining cloud computing and edge computing creates a plurality of offloading options and increases the efficiency of task offloading. For example, clouds generally have sufficient computing resources, and therefore offloading compute-heavy tasks to the cloud can improve the efficiency of task offloading.

Additionally, several studies have conventionally addressed the problem of task offloading in cloud computing and edge computing. Specifically, methods using reinforcement learning (RL) are attracting attention (Non-Patent Literature 1 to Non-Patent Literature 4).

Reinforcement learning can immediately output efficient task offloading by learning in advance the relationship between an input network pattern and an output task offloading.

### CITATION LIST

### Non-Patent Literature

Non-Patent Literature 1: Y. Zhan, S. Guo, P. Li, and J. Zhang, “A deep reinforcement learning based offloading game in edge computing,” IEEE Trans. Comput., vol. 69, No. 6, pp. 883-893, 2020.

Non-Patent Literature 2: D.C. Nguyen, P. N. Pathirana, M. Ding, and A. Seneviratne, “Deep reinforcement learning for collaborative offloading in heterogeneous edge networks,” in Proc. IEEE/ACM CCGrid. IEEE, 2021, pp. 297-303.

Non-Patent Literature 3: W. Hou, H. Wen, H. Song, W. Lei, and W. Zhang, “Multi-agent deep reinforcement learning for task offloading and resource allocation in cybertwin based networks,” IEEE Internet Things J., 2021.

Non-Patent Literature 4: Y. Zhang, B. Di, Z. Zheng, J. Lin, and L. Song, “Distributed multi-cloud multi-access edge computing by multi-agent reinforcement learning,” IEEE Trans. Wireless Commun., vol. 20, No. 4, pp. 2565-2578, 2020.

### SUMMARY OF INVENTION

### Technical Problem

However, the following two problems arise with the conventional method.

The first problem is that existing studies do not consider cloud computing or only target networks with a single cloud server. As mentioned above, combining cloud computing and edge computing is essential to improve the efficiency of task offloading. Furthermore, in a general network, there are a plurality of cloud servers.

The second problem is that existing studies do not take into account bandwidth or the topology of the backbone network, which is the core communication network that connects business operators. Many previous studies try to minimize task delay by shortening the route through which offloaded tasks pass. However, with control that does not take bandwidth into account, congestion may occur due to concentration of task loads on a link.

Additionally, multi-agent reinforcement learning is an effective means for dealing with more complex problems by solving one problem with a plurality of agents. Each agent cooperates with other agents to maximize its reward. By allocating each agent to its own task, the learning cost for each agent can be reduced. However, when each agent learns independently, there is a problem in that each agent will take selfish actions. As a concrete example of this problem, when each agent learns independently and simultaneously and acts independently, all tasks are concentrated on a predetermined cloud server with the lightest load, and as a result, the predetermined cloud server becomes overloaded.

The present invention has been made in view of the above-mentioned problems, and an object of the present invention is to improve the efficiency of task offloading in consideration of network usage statuses such as network topology and bandwidth.

### Solution to Problem

In order to solve the above problem, the invention according to claim 1 provides a control apparatus that controls allocation of a task to a physical network constructed and modeled by respective nodes including respective edge nodes and respective cloud nodes, the control apparatus including: an observation unit that observes task information regarding the task requested by an end device and network usage information indicating a usage status of the physical network; a calculation unit that calculates an optimal specific node for offloading the task based on the observation result of the observation unit; and a transfer unit that transfers the task to the specific node.

### Advantageous Effects of Invention

According to the present invention, the efficiency of task offloading can be improved in consideration of network usage statuses such as network topology and bandwidth.

### BRIEF DESCRIPTION OF DRAWINGS

FIG. 1 is a diagram illustrating an example of an overall configuration of a communication system in an embodiment of the present invention.

FIG. 2 is a conceptual diagram illustrating a physical network of the present embodiment.

FIG. 3 is a hardware configuration diagram of a control apparatus of the present embodiment.

FIG. 4 is a flowchart indicating control of a task offload system.

FIG. 5 is a flowchart indicating control of the task offload system.

FIG. 6 is a diagram indicating each formula.

FIG. 7 is a diagram indicating each formula.

FIG. 8 is a diagram indicating each formula.

FIG. 9 is a diagram indicating each formula.

FIG. 10 is a diagram indicating each formula.

FIG. 11 is a diagram indicating each formula.

FIG. 12 is a diagram indicating Algorithm 1.

FIG. 13 is a diagram indicating Algorithm 2.

FIG. 14 is a diagram indicating Algorithm 3.

FIG. 15 is a diagram indicating Algorithm 4.

FIG. 16 is a diagram indicating each formula.

### DESCRIPTION OF EMBODIMENTS

### [Overview of Embodiment]

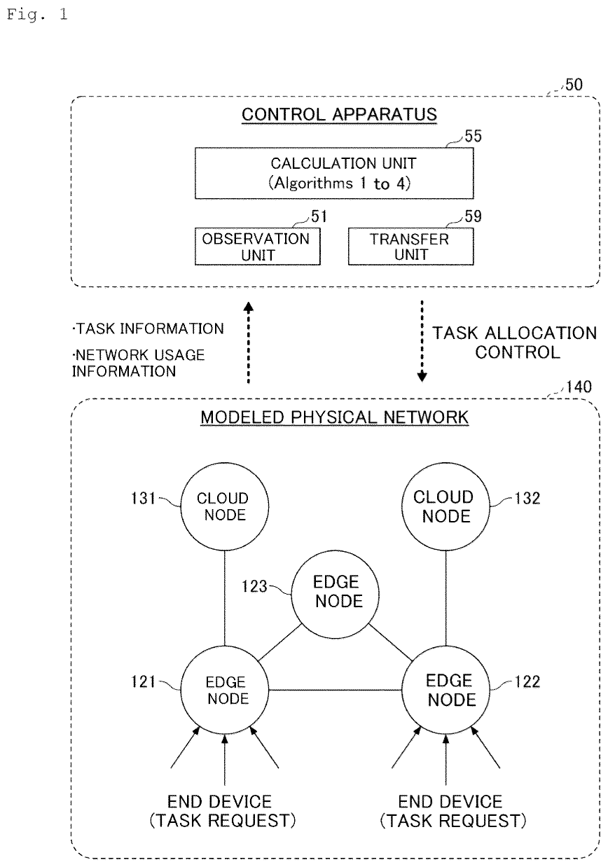

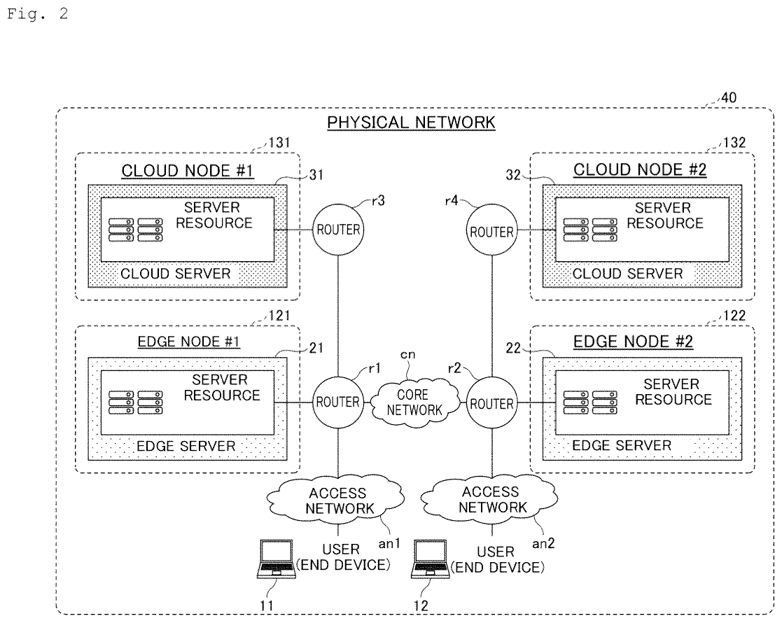

Hereinafter, an overview of a communication system that performs task offloading will be described with reference to FIGS. 1 and 2. FIG. 1 is a diagram illustrating an example of an overall configuration of a communication system in an embodiment of the present invention.

As illustrated in FIG. 1, the communication system of the present embodiment is constructed by a control apparatus 50 and a modeled physical network 140.

The control apparatus 50 acquires task information and network usage information from the modeled physical network 140, and performs control of task allocation to the modeled physical network 140.

Specifically, the control apparatus 50 formulates optimal task offload problems for multi-cloud and multi-edge networks in consideration of constraints on usage statuses of a physical network such as network topology and/or bandwidth. Here, optimal offloading is defined as a solution that maximizes the resource utilization efficiency of servers and links and minimizes task delay while satisfying the constraints of server capacity, link capacity, and task delay. The decision variables here are the allocation of computing resources for the task and the route between an end device and the allocated server. The control apparatus 50 also proposes a task offloading algorithm based on cooperative multi-agent deep reinforcement learning (Coop-MADRL).

The modeled physical network 140 is constructed by a plurality of end devices that request tasks, a plurality of edge nodes 121, 122, and 123, and a plurality of cloud nodes 131 and 132. Note that in FIG. 1, only a limited number of end devices, edge nodes, and cloud nodes are illustrated due to space limitations, but each of them may exist in more than the number of those illustrated in FIG. 1.

FIG. 2 is a conceptual diagram illustrating a physical network of the present embodiment. A physical network 40 is constructed by a plurality of end devices 11 and 12 that request tasks, a plurality of edge servers 21 and 22, and a plurality of cloud servers 31 and 32.

Further, the end device 11 can be connected to the plurality of edge servers 21 and 22 and the plurality of cloud servers 31 and 32 via an access network an1. Similarly, the end device 12 can be connected to the plurality of edge servers 21 and 22 and the plurality of cloud servers 31 and 32 via an access network an2. Further, a core network cn is constructed between the edge server 21 and the edge server 22. The modeled physical network 140 illustrated in FIG. 1 corresponds to the physical network 40 illustrated in FIG. 2. Note that in FIG. 2, only a limited number of end devices, edge nodes, cloud nodes, access networks, and core networks are illustrated due to space limitations, but each of them may exist in more than the number of those illustrated in FIG. 2.

Hereinafter, the end devices 11 and 12 will be collectively referred to as an “end device 10.” The edge servers 21 and 22 are collectively referred to as an “edge server 20.” The cloud servers 31 and 32 are collectively referred to as a “cloud server 30.” The edge nodes 121, 122, and 123 are collectively referred to as an “edge node.” The cloud nodes 131 and 132 are collectively referred to as a “cloud node.” Edge nodes and cloud nodes are collectively referred to as “nodes.” Furthermore, the access networks an1 and an2 are collectively referred to as an “access network an.”

Further, the end device 10 is a personal computer, a smartphone, a smart watch, an IoT device, a home appliance, a communication device mounted on or installed on a mobile object, or the like. Mobile objects include vehicles, aircraft, ships, robots, and the like.

As illustrated in FIG. 2, all nodes have computing resources to execute tasks on behalf of the end device 10 as the edge server 20 or the cloud server 30. All nodes are also connected to routers r1, r2, r3, and r4, which transfer traffic to other nodes, respectively. Each edge server 20 has the control apparatus 50 (see FIG. 1) for determining the optimal node to offload tasks.

The end device 10 is configured by a computer and generates various tasks with various applications. Each task is configured with at least one of information on a required computing resource demand, a traffic demand, or a maximum allowable delay.

Each end device 10 can calculate its own tasks within the end device 10 or offload tasks to an adjacent edge or cloud.

### [Hardware Configuration of Embodiment]

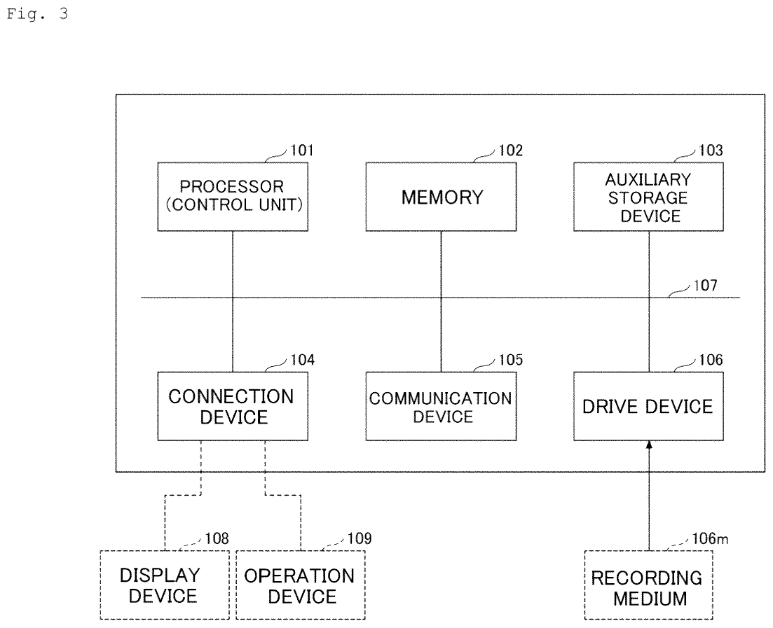

FIG. 3 is a hardware configuration diagram of the control apparatus of the present embodiment.

As illustrated in FIG. 3, the control apparatus 50 includes a processor 101, a memory 102, an auxiliary storage device 103, a connection device 104, a communication device 105, and a drive device 106. Each piece of hardware constituting the control apparatus 50 is interconnected via a bus 107.

The processor 101 serves as a control unit that controls the entire control apparatus 50, and includes various arithmetic devices such as a central processing unit (CPU). The processor 101 reads various programs onto the memory 102 and executes the programs. Note that the processor 101 may include a general-purpose computing on graphics processing units (GPGPU).

The memory 102 has main storage devices such as a read only memory (ROM) and a random access memory (RAM). The processor 101 and the memory 102 form a so-called computer, and the processor 101 executes various programs read onto the memory 102, thereby implementing various functions of the computer.

The auxiliary storage device 103 stores various programs and various types of information used when the various programs are executed by the processor 101.

The connection device 104 is a connection device that connects an external device (for example, a display device 108 and an operation device 109) and the control apparatus 50.

The communication device 105 is a communication device for transmitting and receiving various types of information to and from another device.

The drive device 106 is a device in which a recording medium 106m is set. The recording medium 106m mentioned herein includes a medium that optically, electrically or magnetically records information, such as a compact disc read-only memory (CD-ROM), a flexible disk, or a magneto-optical disk. The recording medium 106m may also include a semiconductor memory that electrically records information, such as a read only memory (ROM) and a flash memory.

Various programs to be installed in the auxiliary storage device 103 are installed, for example, by setting the distributed recording medium 106m in the drive device 106 and reading the various programs recorded in the recording medium 106m by the drive device 106. Alternatively, various programs installed in the auxiliary storage device 103 may be installed by being downloaded from the network via the communication device 105.

Since the end device 10, the edge server 20, and the cloud server 30 have the same hardware configuration as the control apparatus, description thereof will be omitted.

### [Processing of Embodiment]

### <Control Procedure of Task Offload System>

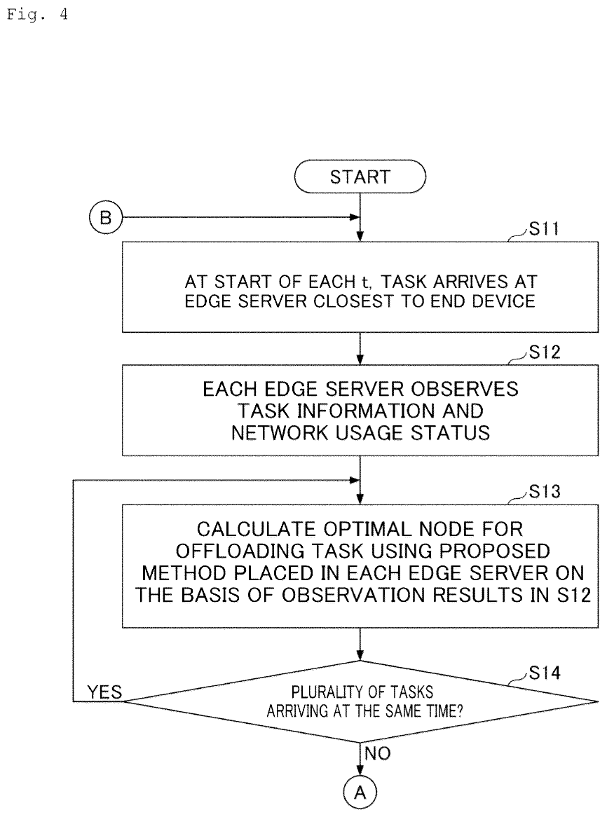

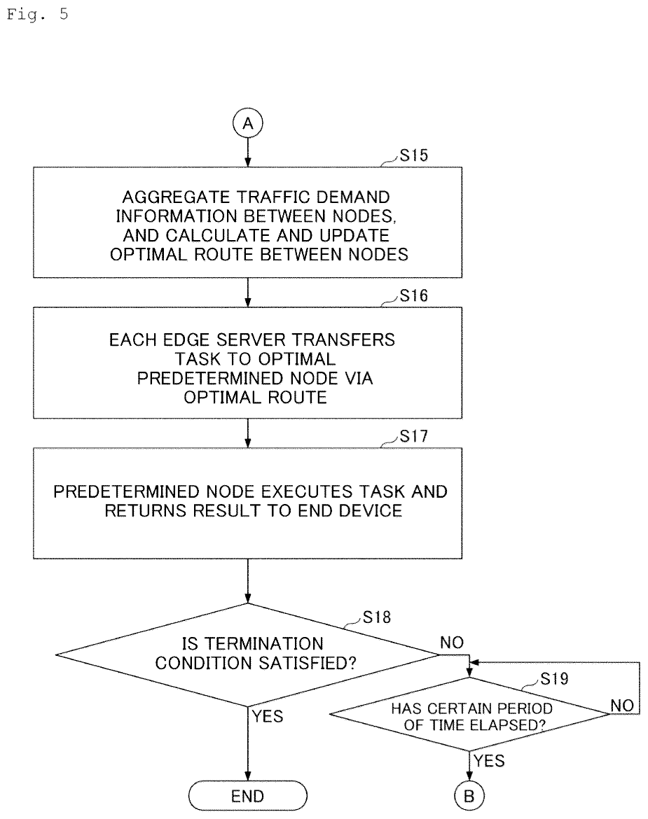

Next, control of the task offload system will be described with reference to FIGS. 4 and 5. FIGS. 4 and 5 are flowcharts indicating control of the task offload system.

Here, a discrete time step t is considered. Assuming that each end device 10 has one or more tasks, K tasks are considered between time steps [0, T]. Specifically, the following processes are executed.

Step S11: At the start of each time step t, a task arrives at the edge server 20 closest to the end device 10.

Step S12: An observation unit 51 of each edge server 20 (control apparatus 50) acquires task information and network usage information to observe the task information and the network usage status. The task information includes at least one of information on a required computing resource demand, a traffic demand, or a maximum allowable delay time. The network information is, for example, information regarding network topology and/or bandwidth as a network usage status. Step S13: A calculation unit 55 of each edge server 20 (control apparatus 50) calculates an optimal specific node for offloading the task using the proposed method placed in the edge server 20 based on the observation results obtained in step S12 (see [Proposed Method] described later for details).

Step S14: When a plurality of tasks arrive at the edge server 20 at the same time (YES), this method repeats determination of the offload node using a first-in first-out (FIFO) method. When a plurality of tasks do not arrive at the same time (NO), the process proceeds to the next step.

Step S15: The calculation unit 55 of each edge server 20 (control apparatus 50) aggregates traffic demand information between nodes, and calculates and updates an optimal route between the nodes.

Step S16: A transfer unit 59 of each edge server 20 (control apparatus 50) transfers the task to the optimal node via the optimal route. Step S17: The node to which the task has been transferred executes the task and returns the result to the requesting end device 10.

Step S18: When a predetermined termination condition is satisfied (YES), the control of the task offload system is terminated. The predetermined termination condition is, for example, when a task request from each end device 10 is terminated. Step S19: When the predetermined termination condition is not satisfied in step S18 (NO), if a certain period of time has elapsed (YES), the process returns to step S11, and the process is repeated in the next time step t+1.

Note that it is assumed that the task being executed continues to consume the resources of the offloaded node and the link through which the task passes until the task returns the result to the end device 10. Therefore, in the present embodiment, a task for which a request is accepted at time step t does not need to be completed by time step t+1.

### <Network Model>

Next, Table 1 shows the definitions of variables in the network model.

TABLE 1

| Symbol | Definition |
|---|---|
| G(N, L) | Network graph |
| n ∈ N | Node |
| link (i, j) ∈ L | Link |
| e ∈ E ⊂ N | Edge |
| c ∈ C ⊂ N | Cloud |
| vᵢ^{N} | i-th node processing capability |
| wᵢ^{N} | i-th node capacity |
| wᵢⱼ^{L} | Capacity of link (i, j) |
| αᵢⱼ^{L} | Distance coefficient of link (i, j) |

A physical network graph G (N, L) composed of a physical node set N and a physical link set L is considered. It is assumed that each node has a role as an edge or a cloud. Here, each edge node E is assumed to be e∈E ⊂N, and each cloud node C is assumed to be c∈C⊂N. Also, the numbers of nodes, edge nodes, and cloud nodes are expressed as |N|, |E|, and |C|, respectively. The end device 10 connects to the nearest edge server 20 via the access network an, but in the present embodiment, it is assumed that the access network an is not included in G(N, L).

Also, the node processing capability of the i-th node is denoted as follows.

$${v}_{i}^{N} \qquad [ Math . 1 ]$$

This indicates the upper limit of the processing capability of the computing resource, such as the CPU capability per second ([G cycles/s]) of the i-th node.

Also, the node capacity of the i-th node is denoted as follows.

$${w}_{i}^{N} \qquad [ Math . 2 ]$$

For example, when one CPU core is allocated to each task,

$${w}_{i}^{N} \qquad [ Math . 3 ]$$

is equal to the number of CPU cores of the i-th node.

The bandwidth capacity of the link (i, j) is denoted as follows.

$${w}_{ij}^{L} \qquad [ Math . 4 ]$$

Also, the bandwidth capacity of the link is denoted as follows.

$${w}_{ij}^{L} \qquad [ Math . 5 ]$$

Furthermore, all links have transmission delays depending on the distance between nodes. Here, the delay time of each link is determined by the following distance coefficient α^{L}ᵢⱼ of link (i, j).

$${α}_{ij}^{L} \qquad [ Math . 6 ]$$

### <Task Model>

Next, Table 2 shows the definitions of the variables of the task model.

TABLE 2

| Symbol | Definition |
|---|---|
| t ∈ T | Time step (T: total time step) |
| [symbol] := {Dₖ} | Task set (k ∈ [symbol] , [symbol] : all tasks ) |
| tₖ | Reception time of task k |
| βₖ | Type of task k |
| Cₖ | Computing resource demand for task k |
| Bₖ^{up}, Bₖ^{down} | Upload/Download traffic demand for task k |
| τₖ^{max} | Maximum allowable delay for task k |

A task model for uniformly expressing various tasks of the end device 10 will be described. The set of tasks is denoted as follows.

$$𝒟 = \{ {D}_{k} \} \qquad [ Math . 7 ]$$

Also, the k-th task is defined as follows.

$${D}_{k} := [ {t}_{k} . {β}_{k} , {C}_{k} , {B}_{k}^{up} , {B}_{k}^{down} , {τ}_{k}^{max} ] \qquad [ Math . 8 ]$$

Here, tₖ∈T is the reception time (time) of task k, βₖ is the type of task k that is uniquely given to each application, and Cₖ is the required computing resource demand ([G cycles]).

In addition,

$${B}_{k}^{up} \qquad [ Math . 9 ]$$

indicates the traffic demand for upload and download.

$${B}_{k}^{down} \qquad [ Math . 10 ]$$

indicates the traffic demand for download.

$${τ}_{k}^{max} \qquad [ Math . 11 ]$$

indicates the maximum allowable delay time ([ms]).

Tasks consume computing resources and network resources on G(N, L) according to the k-th task Dₖ.

When a task is allocated to the edge node closest to the end device 10, the amount of network resources consumed by G(N, L) is assumed to be 0.

### <Formulation of Optimization Problem>

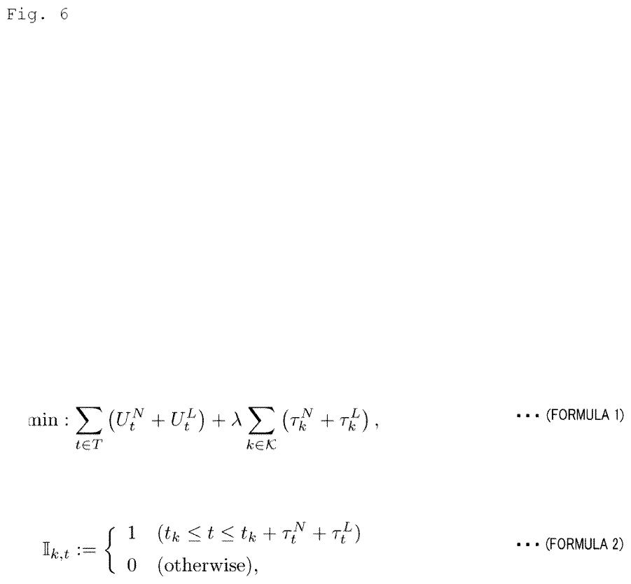

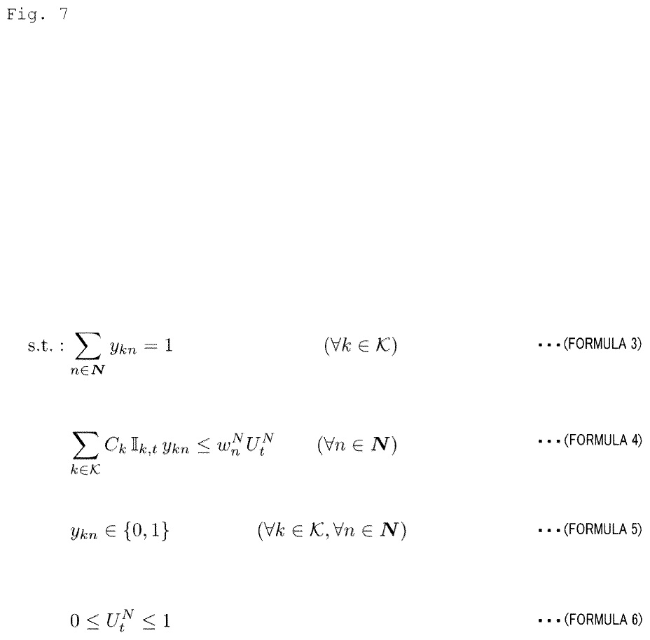

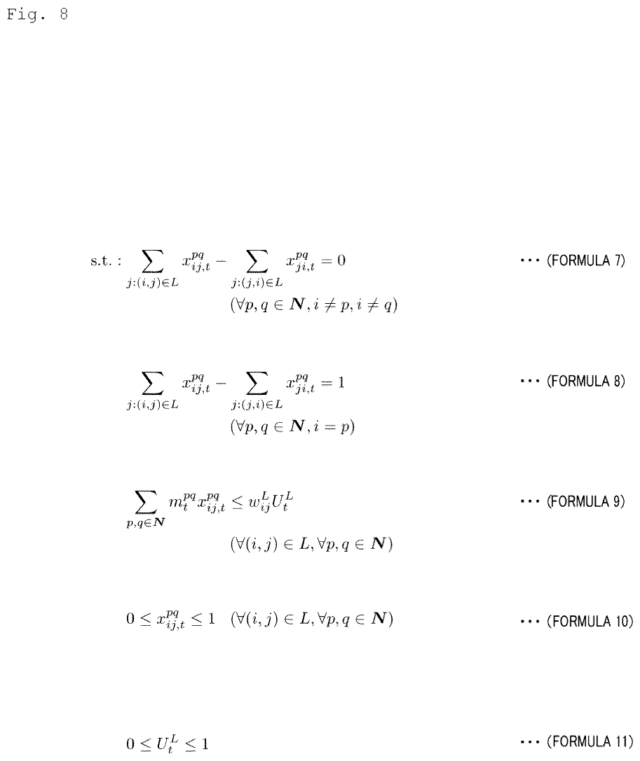

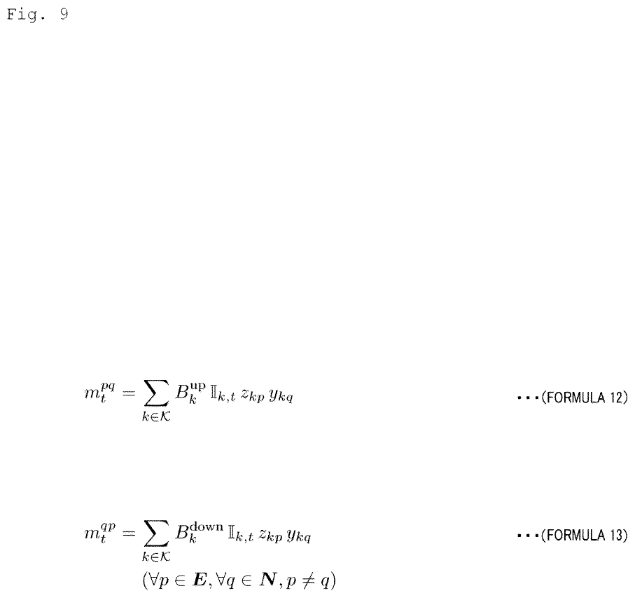

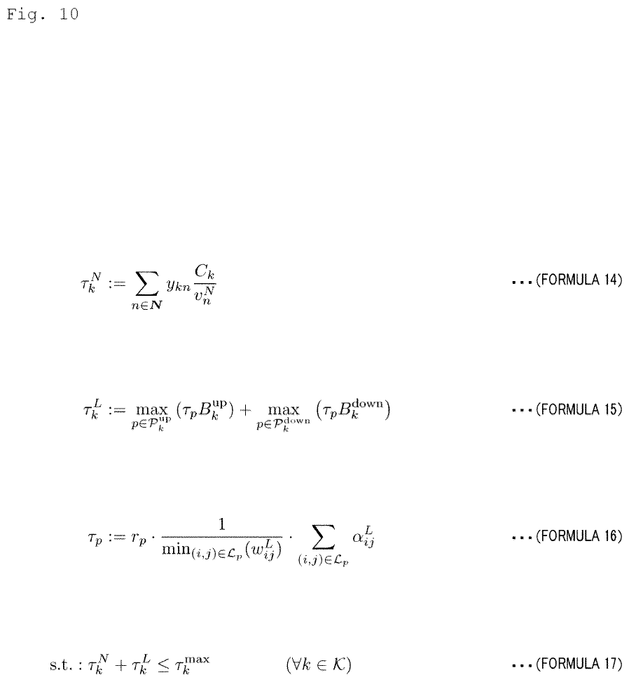

Next, a task offload problem is formulated to minimize (Formula 1) while satisfying the constraint conditions (Formula 2) to (Formula 17) shown in FIGS. 6 to 10. Note that FIGS. 6 to 10 are diagrams indicating each formula.

First, Table 3 shows the definitions of variables for the task offload problem.

TABLE 3

| Symbol | Definition |
|---|---|
| Xₜ := {x_{ij,t}^{pq}} | mₜ^{pq} passing rate on link (i, j) |
| Y := {yₖₙ} | Task allocation (task k, node n) |
| Mₜ := {mₜ^{pq}} | Traffic matrix |
| Z := {zₖₑ} | ED position (task k, edge e) |
| Uₜ^{N} := {u_{i,t}^{N}} | i^{th} node utilization rate |
| Uₜ^{L} := {u_{i,j,t}^{L}} | (i, j) link utilization rate |
| Uₜ^{N} = maxᵢ (Uₜ^{N}) | Maximum node utilization rate |
| Uₜ^{L} = max_{i,j} (Uₜ^{L}) | Maximum link utilization rate |
| τₖ^{N}, τₖ^{L} | Node delay, link delay |
| λ | Objective function weight |
| II_{k,t} | Binary variable that indicates whether or not |
| | task is being executed |
| [symbol] ₖ^{up}, [symbol] ₖ^{down} | Upload traffic route, download traffic route |
| τₚ | Delay coefficient |
| [symbol] | Set of links on route p |
| rₚ | Traffic passing rate on route p |

The decision variables for this problem are the task allocation variable Y and the route allocation variable Xₜ.

Here,

$$Y := \{ {yk}_{n} \} \qquad [ Math . 12 ]$$

is a variable that represents 1 if the computing demand of task k is allocated to node n, and 0 otherwise.

In addition,

$${X}_{t} := \{ {x}_{ij , t}^{pq} \} \qquad [ Math . 13 ]$$

represents the proportion of a demand that passes through the link (i, j) at time step t in the following traffic demand mₜ^{pq} from the start node p to the end node q.

$${m}_{t}^{pq} \qquad [ Math . 14 ]$$

Here,

$${M}_{t} := \{ {m}_{t}^{pq} \} \qquad [ Math . 15 ]$$

represents the traffic demand matrix between the node p and the node q at time step t.

Furthermore, the position of the end device 10 is defined as Zₖₑ. Here, Zₖₑ is a variable that represents 1 if the nearest edge node of task k requested by the end device 10 is e, and 0 otherwise.

Next, the objective function indicated in (Formula 1) is introduced.

Here,

$${U}_{t}^{N} \qquad [ Math . 16 ]$$

$${U}_{t}^{L} \qquad [ Math . 17 ]$$

represent the maximum utilization rate of nodes and links at time step t, and are defined as follows, respectively.

$${U}_{t}^{N} := {max}_{i} ( {U}_{t}^{N} ) \qquad [ Math . 18 ]$$

$${U}_{t}^{L} := {max}_{ij} ( {U}_{t}^{L} ) \qquad [ Math . 19 ]$$

Here, the i-th node utilization rate is denoted as follows.

$${u}_{i , t}^{N} ∈ {U}_{t}^{N} \qquad [ Math . 20 ]$$

Also, the i-th link utilization rate is denoted as follows.

$${u}_{ij , t}^{L} ∈ {U}_{t}^{L} \qquad [ Math . 21 ]$$

In addition,

$${τ}_{k}^{N} \qquad [ Math . 22 ]$$

$${τ}_{k}^{L} \qquad [ Math . 23 ]$$

represent the node delay time and the link delay 10 time of task k.

Further, λ indicates a weighting parameter that. determines the ratio of importance of each term of the objective function.

Next, three types of constraint conditions, that is, node capacity, link capacity, and task delay, are set.

First, a binary variable

$${𝕀}_{k , t} \qquad [ Math . 24 ]$$

is defined as indicated in (Formula 2).

Here,

$${𝕀}_{k , t} \qquad [ Math . 25 ]$$

is a variable that returns 1 if task k is being executed at time step t, and 0 otherwise. Here, tₖ indicates the reception time (time) of task k.

The task allocation variable yₖₙ is formulated to minimize the following maximum node utilization rate Uₜ^{N} while satisfying the node capacity constraints indicated in (Formula 3) to (Formula 6).

$${U}_{t}^{N} \qquad [ Math . 26 ]$$

(Formula 3) indicates that the computing demand of each task needs to be allocated to one of the nodes. (Formula 4) represents the constraint on the capacity of the node.

$${𝕀}_{k , t {𝒴}_{kn}} \qquad [ Math . 27 ]$$

in (Formula 4) indicates the allocation of the task being executed at t.

The route allocation variable

$${x}_{ij , t}^{pq} \qquad [ Math . 28 ]$$

is formulated to minimize the following maximum link utilization rate U, while satisfying the link capacity constraints indicated in (Formula 7) to (Formula 11).

$${U}_{t}^{L} \qquad [ Math . 28 ]$$

$$Here ,$$

$${m}_{t}^{pq} \qquad [ Math . 30 ]$$

in (Formula 9) can be formulated as indicated in (Formula 12) and (Formula 13).

(Formula 12) indicates a request for upload traffic from the transmission source node p to the transmission destination node q. Here, zₖₚ and y_{xq} determine the node p and the node q. In addition,

$${𝕀}_{k , t} \qquad [ Math . 31 ]$$

extracts the task being executed. (Formula 13) indicates the download traffic demand from the node q to the node p, and is the opposite of the upload formula.

The delay time of the task node

$${τ}_{k}^{N} \qquad [ Math . 32 ]$$

and the delay time of the link

$${\text{?}}_{k}^{N} \qquad [ Math . 33 ]$$

$$\text{?} \text{indicates text missing or illegible when filed}$$

are formulated as indicated in (Formula 14) to (Formula 16).

Finally, the latency constraint is formulated as indicated in (Formula 17).

### <Proposed Method>

### (Modeling)

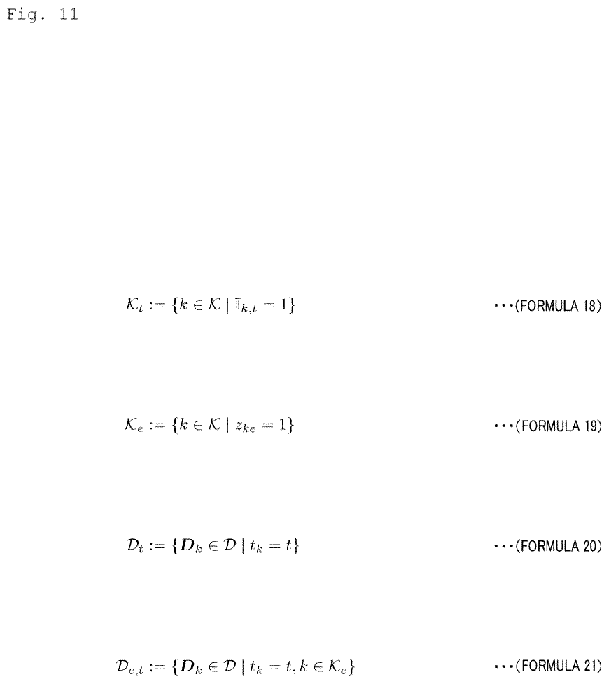

First, variables representing a subset of tasks are defined as indicated in (Formula 18) to (Formula 21) in FIG. 11. FIG. 11 is a diagram indicating each formula.

Here, Kₜ indicates a subset of tasks executed at. time step t. Moreover, Kₑ indicates a subset of tasks accepted by the edge node e. Further, Dₜ indicates a subset of tasks accepted at time step t. Also, D_{e,t} indicates a subset of tasks accepted by the edge node e at time step t.

Here, Table 4 indicates the definitions of the variables of the proposed method.

TABLE 4

| Symbols | Definitions |
|---|---|
| t^{sim} ∈ T^{sim} | Time step of simulator (T^{sim}: total number of steps ) |
| [symbol] := {gₑ} | Agent set (1 ≤ e ≤ \|E\|) |
| sₜ ∈ S | State (S: state space ) |
| [symbol] := { [symbol] ^{e}} | Observation of all agents |
| oₜ^{e} ∈ [symbol] ^{e} | Observation of agent gₑ |
| oₜ := {oₜ^{e}} | Observation of all agents at time step t |
| [symbol] := { [symbol] ^{e}} | Action space of all agents ( [symbol] ^{e}: action space of each agent ) |
| aₜ^{e} := [symbol] ^{e} | Action of agent gₑ |
| aₜ := {aₜ^{e} } | Action of all agents at time step t |
| rₜ | Reward at time step t |
| Qₑ (oₜ^{e}, aₜⁿ) | Action value function of agent gₑ |
| Qₜₒₜ (oₜ, aₜ) | Action value function of all agents |
| [symbol] | Replay memory |

|E| agents equal in number to the number of edge nodes are introduced, and the agents are allocated to task offload control for the edge nodes, respectively.

An agent gₑ∈G learns a method for optimizing task offloading of the edge node e. The state is defined as follows.

$${s}_{t} = [ {D}_{t} , {U}_{t}^{L} , {U}_{t}^{S} ] \qquad [ Math . 34 ]$$

The observation of the agent gₑ is defined as follows

$${o}_{t}^{e} = [ {D}_{e , t} , {U}_{t}^{L} , {U}_{t}^{S} ] \qquad [ Math . 35 ]$$

A candidate set of actions A^{e} is defined as a set of nodes that offload tasks.

When the edge node e does not accept the task at time step t, the agent gₑ selects the action of “doing nothing.” The reward is designed to return a negative value if the constraint condition is not satisfied, and otherwise return a positive value depending on the value of the objective function.

### (Formulation)

The proposed method (Coop-MADRL) performs intensive learning and distributed execution.

### Algorithm 1

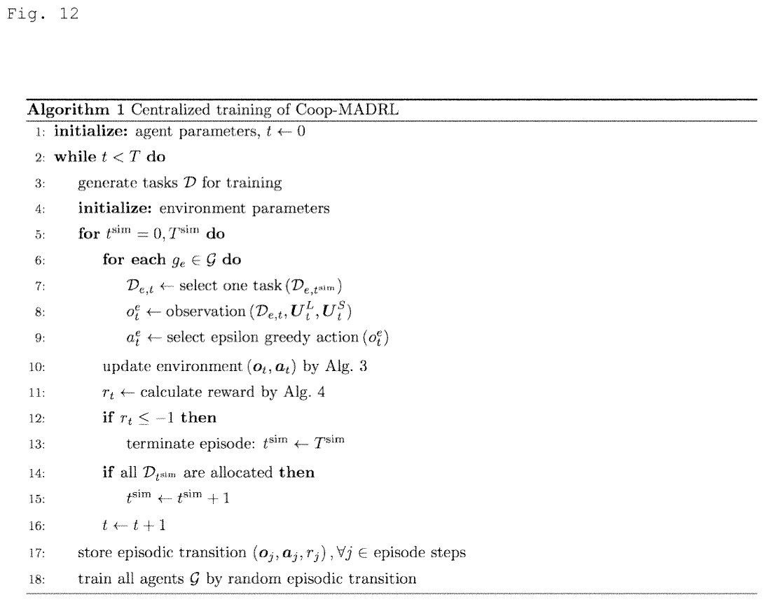

FIG. 12 is a diagram indicating Algorithm 1. Algorithm 1 indicates intensive learning using Coop-MADRL.

Line 1 indicates initialization of agent parameters. A series of procedures (lines 2 to 18) are repeatedly executed until learning is completed. Lines 3 to 4 indicate creation of a task and initialization of environment parameters. A series of actions is called an episode, and each episode (lines 5 to 16) is repeatedly executed.

In each episode, the agent collects training samples that are combinations of <oₜ, aₜ, rₜ>. The time step of the network simulator is t^{sim}, which is reset at the beginning of each episode.

In line 7, when the edge e receives a plurality of tasks in t^{sim}, the agent gₑ selects one task using a FIFO method.

In line 9, a random action is selected with probability ϵ, and if not, an action that maximizes the following is selected with probability 1−ϵ.

$${Q}_{e} ( {o}_{t}^{e} , {a}^{′} ) \qquad [ Math . 36 ]$$

Each agent executes lines 7 to 9 in parallel.

In line 10, the task offload is updated according to at by Algorithm 3.

Line 11 calculates the reward.

Lines 12 to 13 indicate the termination condition of agent learning.

In lines 14 and 15, if all the tasks accepted by t^{sim} have been allocated, the process proceed to the next t^{sim}+1.

Line 17 indicates storage to Replay memory M.

In line 18, all agents G are trained by the history of episodes randomly acquired from M.

### Algorithm 2

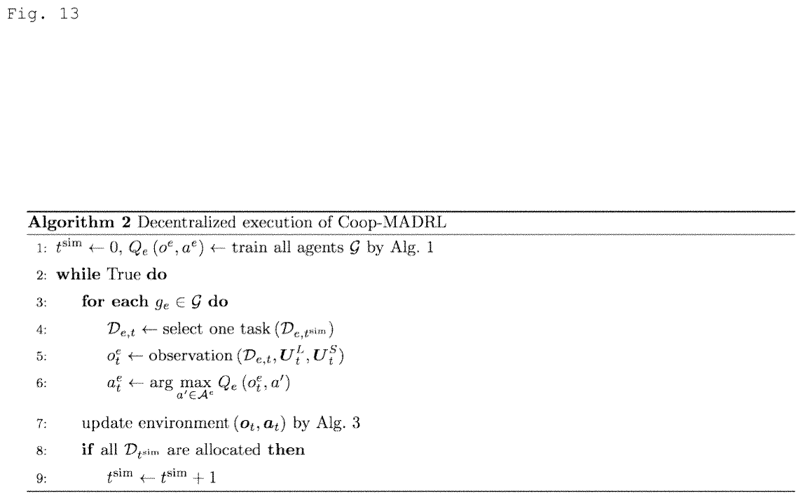

FIG. 13 is a diagram indicating Algorithm 2. Algorithm 2 indicated in FIG. 13 proposes a task offloading method using Coop-MADRL.

In line 1, G is trained in advance using Algorithm 1.

Next, Algorithm 2 continuously repeats lines 2 to 9 as long as the system receives and accepts new tasks.

In line 6, each agent selects the following that maximizes Qₑ (o^{e}, a^{e}).

$${a}_{t}^{e} \qquad [ Math . 37 ]$$

### (Update Environment)

### Algorithm 3

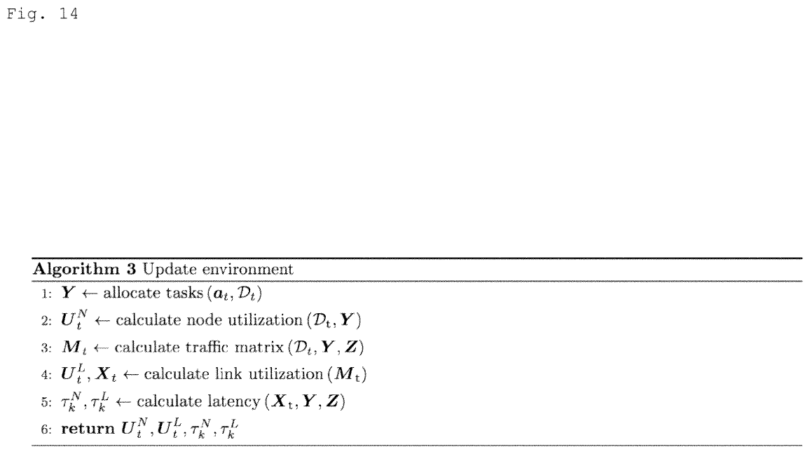

FIG. 14 is a diagram indicating Algorithm 3. Algorithm 3 indicated in FIG. 14 indicates an update procedure of environment. In Algorithm 3, the task allocation variable Y and the route allocation variable Xₜ are updated.

Line 1 indicates the calculation of Y.

Line 2 indicates the calculation of the following.

$${U}_{t}^{N} \qquad [ Math . 38 ]$$

Line 3 indicates the calculation of Mₜ.

Line 4 indicates the calculation of the following.

$${U}_{t}^{N} \qquad [ Math . 39 ]$$

Line 5 indicates the calculation of delay.

Finally, Algorithm 3 returns variables for reward calculation.

### (Reward Calculation)

A reward function is designed based on the objective function (Formula 1).

### Algorithm 4

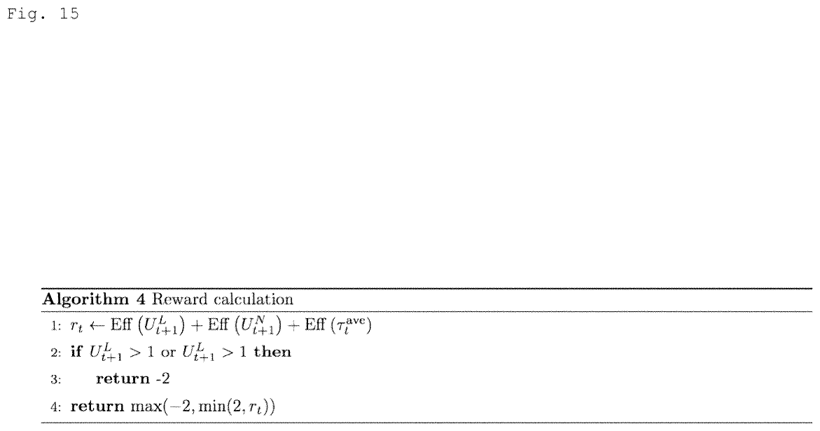

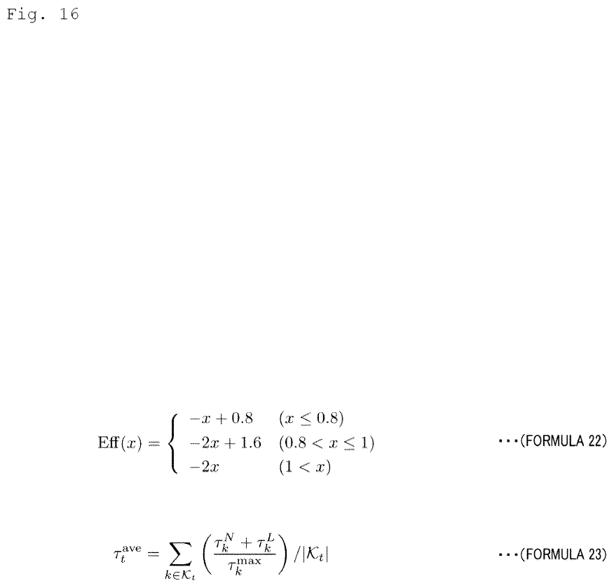

FIG. 15 is a diagram indicating Algorithm 4. Algorithm 4 indicates the procedure for calculating G's reward. Eff(x) represents an efficiency function and is defined as shown in (Formula 22) in FIG. 16. FIG. 16 is a diagram indicating each formula.

The function of (Formula 22) is designed so that the efficiency becomes worse as x becomes larger.

Also, depending on x, it returns a positive value if x<0.8, and a negative value otherwise.

Note that,

$$\text{?} \qquad [ Math . 40 ]$$

$$\text{?} \text{indicates text missing or illegible when filed}$$

indicates an average satisfaction level of latency, and is defined as (Formula 23).

This concludes the description of the proposed method.

### [Main Effects of Embodiment]

According to the present embodiment, the efficiency of task offloading can be improved by introducing a cooperative multi-agent method. That is, an agent that has learned the optimal task offload is placed at each edge. Furthermore, by introducing a mechanism in which each agent learns cooperatively, the selfish action of each agent is prevented. Thereby, the efficiency of task offloading can be improved in consideration of constraints on network usage statuses such as network topology and/or bandwidth.

Furthermore, by using deep reinforcement learning to learn in advance the relationship between network demand patterns and optimal task offloading, efficient task offloading can be quickly obtained.

### [Supplement]

The present invention is not limited to the above-described embodiment, and may be configured or processed (operations) as described below.

For example, the control apparatus 50 can be implemented by a computer and a program, and the program can be recorded in a (non-transitory) recording medium or provided via a communication network such as the Internet.

### REFERENCE SIGNS LIST

11 End device
12 End device
21 Edge server
22 Edge server
31 Cloud server
32 Cloud server
40 Physical network
50 Control apparatus
51 Observation unit
55 Calculation unit
59 Transfer unit
121 Edge node
122 Edge node
131 Cloud node
132 Cloud node
133 Cloud node
140 Modeled physical network

1. A control apparatus comprising:
a processor; and
a memory storing program instructions that cause the processor to:
observe task information regarding a task requested by an end device and network usage information indicating a usage status of a physical network constructed and modeled by nodes including edge nodes and cloud nodes:
calculate an optimal specific node for offloading the task based on a result of the observation; and
transfer the task to the specific node.

2. The control apparatus according to claim 1,
wherein the program instructions cause the processor to calculate an optimal route between the nodes by aggregating traffic demand information between the nodes based on the result of the observation, and
transfer the task to the specific node via the optimal route.

3. The control apparatus according to claim 1, wherein the program instructions cause the processor to calculate the specific node using a task offloading algorithm that is based on cooperative multi-agent deep reinforcement learning, based on the result of the observation.

4. The control apparatus according to claim 1, wherein the task information includes at least one of information on a required computing resource demand, a traffic demand, or a maximum allowable delay time.

5. The control apparatus according to claim 1, wherein the network usage information is information regarding network topology or bandwidth.

6. A control method comprising:
observing task information regarding a task requested by an end device and network usage information indicating a usage status of a physical network constructed and modeled by nodes including edge nodes and cloud nodes;
calculating an optimal specific node for offloading the task based on a result of the observation; and
transferring the task to the specific node.

7. A non-transitory computer-readable recording medium having stored therein a program causing a computer to execute a method comprising:
observing task information regarding a task requested by an end device and network usage information indicating a usage status of a physical network constructed and modeled by nodes including edge nodes and cloud nodes:
calculating an optimal specific node for offloading the task based on a result of the observation; and
transferring the task to the specific node.
